(19) United States
(12) Patent Application Publication
(10) Pub. No.: US 2022/0289522 A1
(43) Pub. Date: Sep. 15, 2022

(54) Elevator Motion Detection Device

(71) Applicants: Carrier Corporation, Palm Beach Gardens, FL (US); Otis Elevator Company, Farmington, CT (US)

(72) Inventors: James Fettinger, Huntington, IN (US); Eric G. Bruce, Huntington, IN (US); Michael Langford, Fort Wayne, IN (US); Paul Cornett, JR., Florence, SC (US)

(21) Appl. No.: 17/653,890

(22) Filed: Mar. 8, 2022

Related U.S. Application Data
(60) Provisional application No. 63/200,473, filed on Mar. 9, 2021.

(51) Int. Cl. B66B 5/00; B66B 3/00; G01P 15/18

(52) U.S. Cl. CPC B66B 5/0025; B66B 3/002; G01P 15/18; H04W 4/38

(57) ABSTRACT

Disclosed is a motion detection device for monitoring movement of a component comprising a housing removably connectable to the component; an indicator arranged within the housing, the indicator being operable to indicate movement of the component; at least one sensor arranged within the housing, the at least one sensor configured to sense data in response to a gravitational force acting thereon; and a controller operably coupled to the at least one sensor and the indicator, the controller including an algorithm configured to determine when the motion detection device is moving and to operate the indicator when the motion detection device is moving.

### CROSS REFERENCE TO A RELATED APPLICATION

The application claims the benefit of U.S. Provisional Application No. 63/200,473 filed Mar. 9, 2021, the contents of which are hereby incorporated in their entirety.

### BACKGROUND

Exemplary embodiments of the present disclosure relate to an elevator system, and more particularly to a motion detection device for monitoring movement of a component during installation of an elevator system.

During installation of an elevator system, materials are initially moved throughout the hoistway via a temporary hoisting device, such as a crane or winch for example. Once the elevator car and counterweight have been connected via the tension members, the elevator car may be used in place of the temporary hoisting device to move the remaining materials to complete installation of the elevator system. Silent movement of these elevator components creates a potential safety hazard for personnel working on the elevator system. Existing systems that are used to monitor movement of these component monitor mechanical movement to detect an unsafe condition.

### BRIEF DESCRIPTION

Disclosed is a motion detection device for monitoring movement of a component comprising a housing removably connectable to the component; an indicator arranged within the housing, the indicator being operable to indicate movement of the component; at least one sensor arranged within the housing, the at least one sensor configured to sense data in response to a gravitational force acting thereon; and a controller operably coupled to the at least one sensor and the indicator, the controller including an algorithm configured to determine when the motion detection device is moving and to operate the indicator when the motion detection device is moving.

In addition to one or more of the above disclosed aspects or as an alternate, further comprising a magnet associated with the housing, wherein the magnet is removably connectable to the component.

In addition to one or more of the above disclosed aspects or as an alternate, wherein the housing is connectable to the component in a plurality of orientations.

In addition to one or more of the above disclosed aspects or as an alternate, wherein the at least one sensor is configured to provide measurements in three directions.

In addition to one or more of the above disclosed aspects or as an alternate, wherein the at least one sensor is an accelerometer.

In addition to one or more of the above disclosed aspects or as an alternate, wherein the indicator includes a noise generating device.

In addition to one or more of the above disclosed aspects or as an alternate, wherein the indicator includes a light.

In addition to one or more of the above disclosed aspects or as an alternate, further comprising a power source operably coupled to the controller, the indicator, and the at least one sensor.

In addition to one or more of the above disclosed aspects or as an alternate, wherein the power source is a battery.

Also disclosed is an elevator system comprising a hoistway; an elevator car movable within the hoistway; a counterweight; at least one tension member connecting the elevator car and the counterweight; a machine operably engaged with the tension member to move the elevator car; and at least one motion detection device removably connected to a component of the elevator system, wherein the at least one motion detection device is configured to detect motion in response to a gravitational force acting on the motion detection device.

In addition to one or more of the above disclosed aspects or as an alternate, wherein the at least one motion detection device is connected to the elevator car.

In addition to one or more of the above disclosed aspects or as an alternate, wherein the at least one motion detection device is connected to the counterweight.

In addition to one or more of the above disclosed aspects or as an alternate, wherein the at least one motion detection device is removably connected to the component of the elevator system via a magnet.

In addition to one or more of the above disclosed aspects or as an alternate, wherein the housing is connectable to the component in a plurality of orientations.

In addition to one or more of the above disclosed aspects or as an alternate, wherein the at least one sensor is configured to provide measurements in three directions.

Also disclosed is a method of indicating movement of a component of an elevator system, comprising: attaching a motion detection device having at least one sensor to a movable element of an elevator system; sensing data via the at least one sensor of the motion detection device, wherein the sensed data is dependent on a gravitational force acting on the at least one sensor; evaluating the sensed data to determine if the component is moving; and operating an indicator in response to determining that the component is moving.

In addition to one or more of the above disclosed aspects or as an alternate, wherein evaluating the sensed data further comprises determining a change in the sensed data over time and comparing the change in the sensed data to a predetermined threshold.

In addition to one or more of the above disclosed aspects or as an alternate, wherein the sensed data is acceleration, and evaluating the sensed data includes determining a velocity from the acceleration.

In addition to one or more of the above disclosed aspects or as an alternate, wherein evaluating the sensed data further comprises removing noise from the sensed data by rejecting sensed data that exceeds at least one noise threshold value.

In addition to one or more of the above disclosed aspects or as an alternate, wherein evaluating the sensed data further comprises changing an indicated state of motion of the device from stationary to moving when a change in the sensed data over time exceeds above a first threshold value and changing the indicated state of motion of the device from moving to stationary when the change in the sensed data over time recedes below a second threshold value.

In addition to one or more of the above disclosed aspects or as an alternate, wherein the first threshold value is greater than the second threshold value.

In addition to one or more of the above disclosed aspects or as an alternate, further comprising performing work on the elevator system, and removing the motion detection device from the movable element of the elevator system.

### BRIEF DESCRIPTION OF THE DRAWINGS

The following descriptions should not be considered limiting in any way. With reference to the accompanying drawings, like elements are numbered alike:

FIG. 1 is a cross-sectional view of an example of an elevator system;

FIG. 2 is a schematic diagram of a portion of an elevator system including a motion detection device according to an embodiment; and

FIG. 3 is a schematic diagram of a motion detection device according to an embodiment.

FIG. 4 is a schematic illustration of a method of determining movement of the motion detection device.

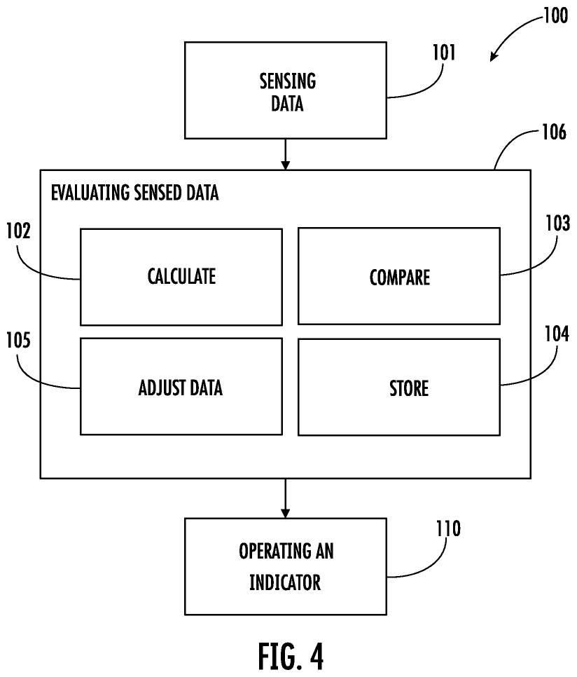

### DETAILED DESCRIPTION

A detailed description of one or more embodiments of the disclosed apparatus and method are presented herein by way of exemplification and not limitation with reference to the Figures.

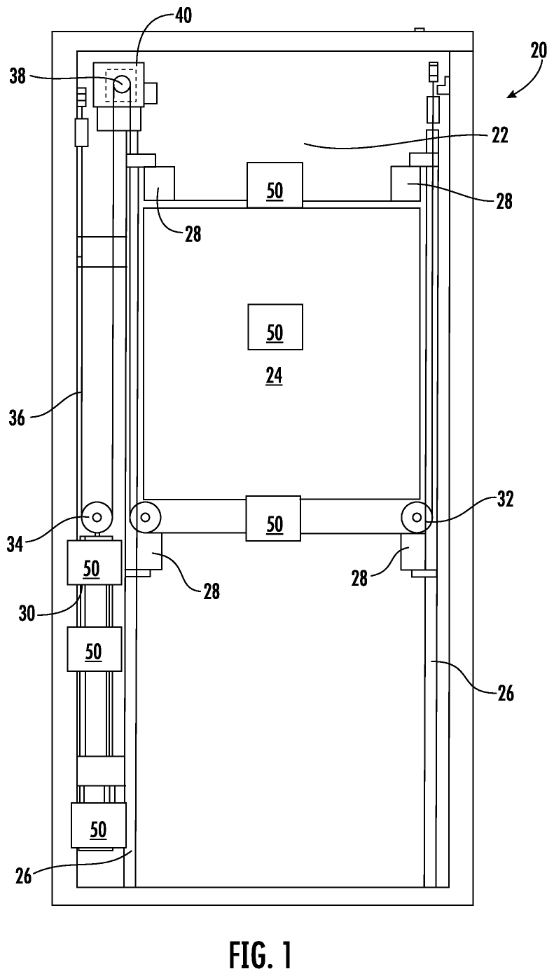

With reference now to FIG. 1, an example of elevator system 20 is illustrated. The elevator system 20 includes an elevator car 24 configured to move vertically upwardly and downwardly within a hoistway 22 between a plurality of floors along a plurality of car guide rails 26. Guide assemblies 28 mounted to the top and bottom of the elevator car 24 are configured to engage the car guide rails 26 to maintain proper alignment of the elevator car 24 as it moves within the hoistway 22.

The elevator system 20 also includes a counterweight 30 configured to move vertically upwardly and downwardly within the hoistway 22. The term counterweight 30 as used herein includes a counterweight assembly that may itself include various components as would be understood by a person skilled in the art. The counterweight 30 moves in a direction generally opposite the movement of the elevator car 24 as is known in conventional elevator systems. Movement of the counterweight 30 is guided by counterweight guide rails (not shown) mounted within the hoistway 22. In the illustrated, non-limiting embodiment, the elevator car 24 and counterweight 30 include sheave assemblies 32.34, respectively, that cooperate with tension members 36 and a traction sheave 38 mounted to a drive machine 40 to raise and lower the elevator car 24. The drive machine 40 in the illustrated, non-limited embodiment, is suited and sized for use with flat tension members 36. The sheave assembly 32, shown in FIG. 1, is mounted to the bottom of the elevator car 24, such that the elevator system 20 has an underslung configuration. However, the sheave assemblies 32 may be mounted at another location on the elevator car 24, such as at the top thereof i.e. an overslung configuration for example, or elsewhere in the system 20 as recognized by a person skilled in the art.

The drive machine 40 of the elevator system 20 is positioned and supported at a mounting location atop a support member (not shown), such as a bed plate for example, in a portion of the hoistway 22 or a machine room. Although the elevator system 20 illustrated and described herein has an underslung 2:1 roping configuration, it should be understood that systems 20 having other roping configurations and hoistway layouts are also within the scope of the disclosure.

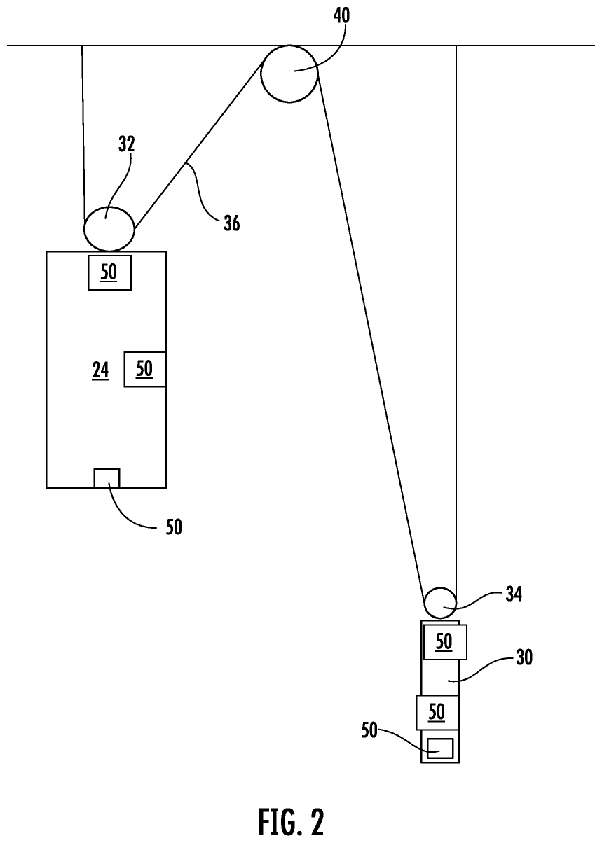

Prior to completion of the installation, the elevator car 24 may be driven within the hoistway 22, in place of a temporary hoist, to transport materials required to complete the installation. A motion detection device 50 is connectable to a portion of the elevator system 20 and is operable to detect and indicate when the elevator car 24 and/or the counterweight 30 is moving within the hoistway 22. A motion detection device 50 may be connected to one or more of the elevator car 24, the counterweight 30, or another component of the propulsion system, including but not limited to the drive machine 40, tension members 36, and sheaves 32, 34 for example. In the illustrated, non-limiting embodiment of FIG. 2, the elevator system 20 includes a first motion detection device 50 affixed to the elevator car 24 and a second motion detection device 50 affixed to the counterweight 30. Because the elevator car 24 and counterweight 30 move opposite one another, inclusion of separate devices 50 for monitoring and indicating the movement of both the elevator car 24 and counterweight 30 provides increased safety for personnel working at different locations throughout the hoistway 22.

Because the motion detection device 50 is intended for use during construction of the elevator system 20, the motion detection device 50 is configured to removably couple to a portion of the elevator system 20. The motion detection device 50 may be attached to a respective component via any suitable means, such as via one or more fasteners (e.g., hook and loop style fastener, snap, strap, cooperating and/or corresponding tab and hole, or tongue and groove, clip, hook, adhesive, and the like). In an embodiment, the motion detection device 50 includes one or more magnets configured to cooperate with and removably affix to a magnetic or metal material of the elevator car 24 or counterweight 30.

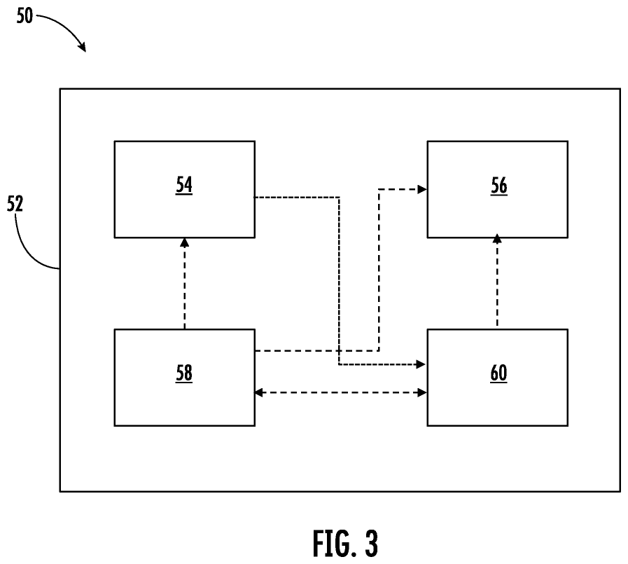

With reference now to FIG. 3, an example of a motion detection device 50 is illustrated in more detail. The motion detection device 50 can be a self-contained portable device. A housing 52 of the motion detection device 50 can be formed from a durable plastic material (e.g., including polycarbonate, polyethylene, polyvinyl chloride, acrylonitrile butadiene styrene (ABS), and the like) to minimize the weight of the motion detection device 50. However, embodiments where the housing 52 is formed from another material, such as metal for example, are also contemplated herein. Located within the housing 52 is at least one sensor 54 and an indicator 56. The indicator 56 can include a sound generation mechanism operable to generate an audible alarm, such as in response to detection of a specific condition. Alternatively, or in addition, the indicator 56 may be partially exposed at an exterior of the housing 52 (e.g., through an opening in the housing 52) and operable to visually indicate that the condition has been detected. In an embodiment, the visual indicator may be a light, such as a flashing light for example.

The motion detection device 50 can include a power source 58 configured to provide power to both the at least one sensor 54 and the indicator 56. Further, the motion detection device 50 can include a compartment for receiving one or more batteries 58. The compartment, and batteries 58 disposed therein, can be sized sufficiently to provide the power necessary to operate the motion detection device 50 for an extended period of time, such as days, weeks, or even months. In an embodiment, the power provided by the batteries 58 can be the sole source of power used to operate the motion detection device 50.

The at least one sensor 54 is operable to detect one or more parameters of the component to which the motion detection device 50 is coupled, such as movement of the component for example. In an embodiment, the at least one sensor 54 is an accelerometer. Further, the accelerometer 54 may be configured to take measurements relative to a single axis, two axes, or three axes. By using a sensor 54 capable of sensing in multiple directions, the motion detection device 50 can be operable regardless of the orientation of the motion detection device 50 when mounted within the hoistway 22. Further, such a motion detection device 50 can be capable of detecting not only vertical movement of the elevator car 24 within a hoistway 22, but also in some embodiments, horizontal movement of the elevator car 24, such as between adjacent hoistways, through transfer stations, and/or in car parking areas for example.

The motion detection device 50 additionally includes a controller 60 operably coupled to each of the power source 58, the indicator 56 and the at least one sensor 54. The controller 60 may include one or more input/output (I/O) logic units such as a microprocessor, microcontroller, application specific integrated circuit (ASIC), or any other form of electronic controller known in the art. The controller 60 can be configured to operate the indicator 56 in response to the sensed data provided to the controller 60 by the at least one sensor 54. The controller can be configured to run an algorithm operable to evaluate the sensed data to determine when the motion detection device 50 is moving. In an embodiment, the algorithm is stored in a memory within the controller 60 (e.g., non-volatile memory). Optionally, the controller 60 may include or interface a wireless communication device which can allow for remote interaction with the motion detection device 50. For example, a remote communications device can allow for data to be transferred between the motion detection device 50 and a remote device (e.g., a smart phone, a service tool, a central station, and the like), remote activation of the indicator 56, and the like. In an embodiment, the controller 60 may be able to access an algorithm stored in a remote database, such as via wireless communication for example.

During operation of the motion detection device 50, the at least one sensor communicates signals representative of the sensed parameter to the controller 60. The at least one sensor 54 may provide a continuous signal to the controller 60 or may send a signal to the controller 60 at known intervals, such as every 0.1 seconds for example. The controller 60 uses the information provided by the at least one sensor 54 to evaluate a condition of the motion detection device 50. The one or more parameters detected by the at least one sensor can be reliant on gravity as opposed to mechanical movement of a component. Gravity sense determines orientation in the x, y or z axis of the unit and automatically reads the appropriate sensor axis output based on position. This allow for reduction in noise from vibration in non-traveling axis. Examples of such sensors include velocity sensors and accelerometers mounted in the x axis will ignore sensor readings in the y and z axis. In embodiments where the at least one sensor 54 is an accelerometer, the controller 60 may be configured to a calculate velocity from the sensed acceleration and may use this velocity to detect movement of the motion detection device 50. In an embodiment, the algorithm is configured to evaluate the change in the sensed acceleration versus time, or the change in the velocity calculated based on the sensor acceleration versus time, to determine when the motion detection device 50, and therefore the component (e.g., the elevator 24 car or counterweight 30) to which the motion detection device is connected, is moving within the hoistway 22.

When the change in the sensed acceleration, or the change in calculated velocity, exceeds a predetermined threshold, thereby indicating that the motion detection device 50 is moving, the controller 60 provides a signal to the indicator 56 and/or to the power source 58 to energize the indicator 56, thereby causing the indicator 56 to operate. The indicator 56 may be configured to provide a visual and/or audible warning for a fixed period of time or, in some embodiments, until the indicator 56 or power source 58 receives another signal from the controller 60 upon determining that the motion detection device 50 is no longer moving.

Further, in an embodiment, the algorithm includes a filtering function capable of distinguishing between actual motion and drift or noise inherent in operation of the sensor 54. This filtering may be performed by continuously rejecting acceleration measurements that are determined to be noise and by having properly calibrated the sensor upon startup for optimal rejection of drift. Mathematical calculations can determine drift range for sensor angle, movement, and resting state. These calculations can adjust the sensitivity to movement and allow for longer runs at slower speeds to provide a more accurate motion sensing which can be important during elevator installation. Acceleration, deceleration, and constant velocity can be monitored to detect and alert system movement.

The algorithm includes steps 100 for determining movement of the motion detection device 50. The steps of the method can operate simultaneously or in a temporal sequence in arriving at a present state of the motion detection device 20. A first step 101 can include sensing instantaneous data from the at least one sensor 54 and at least temporarily storing the instantaneous data in system memory. A second step 106 can include evaluating the sensed instantaneous data. This evaluation can include a first sub steps 102 for calculating a parameter indicative of movement (e.g., change in position, velocity, acceleration, or the like), a second sub step 103 comparing the parameter to one or more thresholds (e.g., signal noise threshold, alert threshold, start movement threshold, stop movement threshold, and the like), comparing the parameter to one or more prior recordings of the same parameter, rejecting the parameter if determined to be noise, a third sub step 104 recording the parameter to memory within the controller 60, a fourth sub step 105 for adjusting the parameter based on deviation of the sensed instantaneous value from a time averaged value (e.g., interpolating an adjustment to be applied to the sensed data measurement based on a difference between the parameter and the time averaged value of the same), or a combination comprising at least one of the foregoing.

Evaluating the sensed data from the at least one sensor 54 can include comparing the sensed data to one or more predetermined thresholds to determine the state of motion of the device. For example, the motion detection device 50 can use a hysteresis type control to determine if the device is or is not in motion. In an embodiment, when the motion detection device 50 is beginning to move it can change its estimation of the state of motion from stationary to moving when a parameter (e.g., the absolute value of instantaneous velocity) rises above a first threshold value (e.g., K). Correspondingly, when the motion detection device 50 is stopping it can change its estimation of the state of motion from moving to stationary when a parameter (e.g., the absolute value of instantaneous velocity) falls below a second threshold value (e.g., Km). Further, Ks can be greater than Km to prevent rapid oscillation from moving to stationary and back while the motion detection device 50 is experiencing a change from rest to motion or from motion to rest. Optionally, when the state of motion of the motion detection device 50 is determined to be stationary the controller 60 can bias the sensed data toward zero to reduce sensor drift.

A third step 110 can include operating the indicator 56 of the motion detection device 50 when the device determines the state of motion to be moving. For example, when the absolute value of the instantaneous velocity exceeds the first threshold value the indicator 56 can be activated alerting nearby personnel that the device is in motion, and correspondingly an element of the elevator system the motion detection device is attached to is in motion.

The motion detection device 50 illustrated and described herein is configured to determine movement in response to the gravitational force acting thereon. As a result, the motion detection device 50 provides more accurate motion detection than existing systems. In addition, because the motion detection device 50 is operable to detect movement via gravity, the motion detection device 50 is easy to install and run without relying on the mechanical movement of a component of the elevator system 20.

The motion detection device 50 can include a power button or switch disposed along an exterior portion of the housing 52 to allow the user to activate the device. In an example, an elevator technician can attach the motion detection device 50 to a counterweight 30 and/or car 24 of the elevator system 20 and power it on prior to performing installation and/or maintenance activities in a hoistway 22 thereby providing a visual and audible warning when the counterweight 30 and/or car 24 move.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A motion detection device for monitoring movement of a component comprising:
a housing removably connectable to the component;
an indicator arranged within the housing, the indicator being operable to indicate movement of the component;
at least one sensor arranged within the housing, the at least one sensor configured to sense data in response to a gravitational force acting thereon; and
a controller operably coupled to the at least one sensor and the indicator, the controller including an algorithm configured to determine when the motion detection device is moving and to operate the indicator when the motion detection device is moving.

2. The motion detection device of claim 1, further comprising a magnet associated with the housing, wherein the magnet is removably connectable to the component.

3. The motion detection device of claim 1, wherein the housing is connectable to the component in a plurality of orientations.

4. The motion detection device of claim 1, wherein the at least one sensor is configured to provide measurements in three directions.

5. The motion detection device of claim 1, wherein the at least one sensor is an accelerometer.

6. The motion detection device of claim 1, wherein the indicator includes a noise generating device.

7. The motion detection device of claim 1, wherein the indicator includes a light.

8. The motion detection device of claim 1, further comprising a power source operably coupled to the controller, the indicator, and the at least one sensor.

9. The motion detection device of claim 8, wherein the power source is a battery.

10. An elevator system comprising:
a hoistway;
an elevator car movable within the hoistway;
a counterweight;
at least one tension member connecting the elevator car and the counterweight;
a machine operably engaged with the tension member to move the elevator car; and
at least one motion detection device removably connected to a component of the elevator system, wherein the at least one motion detection device is configured to detect motion in response to a gravitational force acting on the motion detection device.

11. The elevator system of claim 10, wherein the at least one motion detection device is connected to the elevator car.

12. The elevator system of claim 10, wherein the at least one motion detection device is connected to the counterweight.

13. The elevator system of claim 10, wherein the at least one motion detection device is removably connected to the component of the elevator system via a magnet.

14. The elevator system of claim 10, wherein the housing is connectable to the component in a plurality of orientations.

15. The elevator system of claim 10, wherein the at least one sensor is configured to provide measurements in three directions.

16. A method of indicating movement of a component of an elevator system, comprising:
attaching a motion detection device having at least one sensor to a movable element of an elevator system;
sensing data via the at least one sensor of the motion detection device, wherein the sensed data is dependent on a gravitational force acting on the at least one sensor;
evaluating the sensed data to determine if the component is moving; and
operating an indicator in response to determining that the component is moving.

17. The method of claim 16, wherein evaluating the sensed data further comprises determining a change in the sensed data over time and comparing the change in the sensed data to a predetermined threshold.

18. The method of claim 16, wherein the sensed data is acceleration, and evaluating the sensed data includes determining a velocity from the acceleration.

19. The method of claim 16, wherein evaluating the sensed data further comprises removing noise from the sensed data by rejecting sensed data that exceeds at least one noise threshold value.

20. The method of claim 16, wherein evaluating the sensed data further comprises changing an indicated state of motion of the device from stationary to moving when a change in the sensed data over time exceeds above a first threshold value and changing the indicated state of motion of the device from moving to stationary when the change in the sensed data over time recedes below a second threshold value.

21. The method of claim 20, wherein the first threshold value is greater than the second threshold value.

22. The method of claim 16, further comprising performing work on the elevator system, and removing the motion detection device from the movable element of the elevator system.
